(19) United States
(12) Patent Application Publication
(10) Pub. No.: US 2014/0137736 A1
(43) Pub. Date: May 22, 2014

(54) MEMBRANE DERIVED FROM POLYETHER- AND SILICEOUS FILLER-CONTAINING SILICONE COMPOSITION

(71) Applicants: Dongchan Ahn, Midland, MI (US); Aaron J. Greiner, Midland, MI (US); James S. Hrabal, St. Louis, MI (US); Christopher Wong, Los Angeles, CA (US)

(72) Inventors: Dongchan Ahn, Midland, MI (US); Aaron J. Greiner, Midland, MI (US); James S. Hrabal, St. Louis, MI (US); Christopher Wong, Los Angeles, CA (US)

(73) Assignee: Dow Corning Corporation, Midland, MI (US)

(21) Appl. No.: 14/123,917

(22) PCT Filed: Jun. 6, 2012
(86) PCT No.: PCT/US2012/041113

§ 371 Date: Feb. 6, 2014

Related U.S. Application Data
(60) Provisional application No. 61/493,908, filed on Jun. 6, 2011.

(51) Int. Cl. B01D 71/70; B01D 69/08; B01D 53/22

(52) U.S. Cl. CPC B01D 71/70; B01D 53/228; B01D 69/08
USPC 95/51; 96/4; 96/12; 95/45; 96/10; 95/52

(57) ABSTRACT

The present invention relates to silicone compositions that are useful for the production of membranes that are selectively permeable to at least one component of a gas mixture. The invention provides a method of forming the membrane. The invention also provides a method of separating components in a feed mixture using the membrane. The membrane includes a reaction product (e.g. cured product) of a silicone composition including an organopolysiloxane having at least two unsaturated aliphatic carbon-carbon bond-containing groups per molecule; a crosslinking agent having at least two silicon-bonded hydrogen atoms per molecule; a hydrosilylation catalyst; a polyether containing at least one unsaturated aliphatic carbon-carbon bond-containing group; and a siliceous filler.

### CLAIM OF PRIORITY

This application claims the benefit of priority of U.S. application Ser. No. 61/493,908, filed Jun. 6, 2011, entitled “MEMBRANE DERIVED FROM POLYETHER- AND SILICEOUS FILLER-CONTAINING SILICONE COMPOSITION,” which application is herein incorporated by reference in its entirety

### BACKGROUND OF THE INVENTION

Artificial membranes can be used to perform separations on both a small and large scale, which makes them very useful in many settings. For example, membranes can be used to purify water, to cleanse blood during dialysis, and to separate gases. Some common driving forces used in membrane separations are pressure gradients and concentration gradients. Membranes can be made from polymeric structures, for example, and can have a variety of surface chemistries, structures, and production methods. Membranes can be made by hardening or curing a composition.

The use of membranes to separate gases is an important technique that can be used in many industrial procedures. Examples can include recovery of hydrogen gas in ammonia synthesis, recovery of hydrogen in petroleum refining, separation of methane from other components in biogas synthesis, enrichment of air with oxygen for medical or other purposes, removal of water vapor from natural gas, removal of carbon dioxide (CO₂) and dihydrogen sulfide (H₂S) from natural gas, and carbon-capture applications such as the removal of CO₂ from flue gas streams generated by combustion processes.

### SUMMARY OF THE INVENTION

The present invention relates to silicone compositions that are useful for the production of membranes that are selectively permeable to at least one component of a gas mixture. The invention provides a method of forming the membrane. The invention also provides a method of separating components in a feed mixture using the membrane. The membrane includes a reaction product of a silicone composition that includes an organopolysiloxane having at least two unsaturated aliphatic carbon-carbon bond-containing groups per molecule; a crosslinking agent having at least two silicon-bonded hydrogen atoms per molecule; a hydrosilylation catalyst; a polyether containing at least one unsaturated aliphatic carbon-carbon bond-containing group; and, a siliceous filler.

The present invention provides advantages over other known membranes. For example, in some embodiments surprisingly the combination of a polyether containing at least one unsaturated aliphatic carbon-carbon bond-containing group and a siliceous filler together in the composition acts to improve the gas permeation properties of the resulting polysiloxane membrane for separation of gas mixtures, such as those containing CO₂. For example, Membranes of the present invention can exhibit both high permeability and selectivity for particular components in a gas mixture. For example, in some embodiments the membrane of the present invention can exhibit high CO₂/N₂ and CO₂/CH₄ selectivity compared with PDMS membranes cured by hydrosilylation, while retaining high permeability, such as high CO₂ permeability. Various embodiments can provide a method of separating gas mixtures for a variety of industrially important and energy/environment driven applications such as carbon capture, natural gas sweetening, and production of hydrogen.

The present invention provides an unsupported membrane. The unsupported membrane includes a reaction product of a silicone composition. The silicone composition includes an organopolysiloxane. The organopolysiloxane has an average of at least two silicon-bonded unsaturated aliphatic carbon-carbon bond-containing groups per molecule. The silicone composition includes an organosilicon compound. The organosilicon compound has an average of at least two silicon-bonded hydrogen atoms per molecule. The silicone composition includes a polyether. The polyether has at least one unsaturated aliphatic carbon-carbon bond-containing group per molecule. The silicone composition includes a siliceous filler. The silicone composition includes a hydrosilylation catalyst. The unsupported membrane is free-standing.

The present invention provides a supported membrane. The supported membrane includes a substrate. The substrate includes a porous substrate or a highly-permeable nonporous substrate. The membrane also includes the reaction product of a silicone composition. The reaction product of the silicone composition is on the porous substrate. The silicone composition includes an organopolysiloxane. The organopolysiloxane has an average of at least two silicon-bonded unsaturated aliphatic carbon-carbon bond-containing groups per molecule. The silicone composition includes an organosilicon compound. The organosilicon compound has an average of at least two silicon-bonded hydrogen atoms per molecule. The silicone composition includes a polyether. The polyether has at least one unsaturated aliphatic carbon-carbon bond-containing group per molecule. The silicone composition includes a siliceous filler. The silicone composition includes a hydrosilylation catalyst. The membrane is a supported membrane.

The present invention provides a method of forming a membrane. The method includes forming a coating. The coating includes an organopolysiloxane. The organopolysiloxane has an average of at least two silicon-bonded unsaturated aliphatic carbon-carbon bond-containing groups per molecule. The coating includes an organosilicon compound. The organosilicon compound has an average of at least two silicon-bonded hydrogen atoms per molecule. The coating includes a polyether. The polyether has at least one unsaturated aliphatic carbon-carbon bond-containing group per molecule. The coating includes a siliceous filler. The coating includes a hydrosilylation catalyst. The method also includes curing the coating. Curing the coating provides a membrane.

The present invention provides a method of separating gas components in a feed gas mixture. The method includes contacting a first side of a membrane with a feed gas mixture. The membrane includes a reaction product of a silicone composition. The feed gas mixture includes at least a first gas component and a second gas component. Contacting the first side of the membrane with the feed gas mixture produces a permeate gas mixture on the second side of the membrane and a retentate gas mixture on the first side of the membrane. The permeate gas mixture is enriched in the first gas component. The retentate gas mixture is depleted in the first gas component. The silicone composition includes an organopolysiloxane. The organopolysiloxane has an average of at least two silicon-bonded unsaturated aliphatic carbon-carbon bond-containing groups per molecule. The silicone composition includes an organosilicon compound. The organosilicon compound has an average of at least two silicon-bonded hydrogen atoms per molecule. The silicone composition includes a polyether. The polyether has at least one unsaturated aliphatic carbon-carbon bond-containing group per molecule. The silicone composition includes a siliceous filler. The silicone composition includes a hydrosilylation catalyst.

### DETAILED DESCRIPTION OF THE INVENTION

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.1% to 0.5%, 1.1% to 2.2%, 3.3% to 4.4%) within the indicated range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The term “about” can allow for a degree of variability in a value or range, for example, within 10%, or within 5% of a stated value or of a stated limit of a range.

The terms “M”, “D”, “T”, and “Q” as used herein designate:

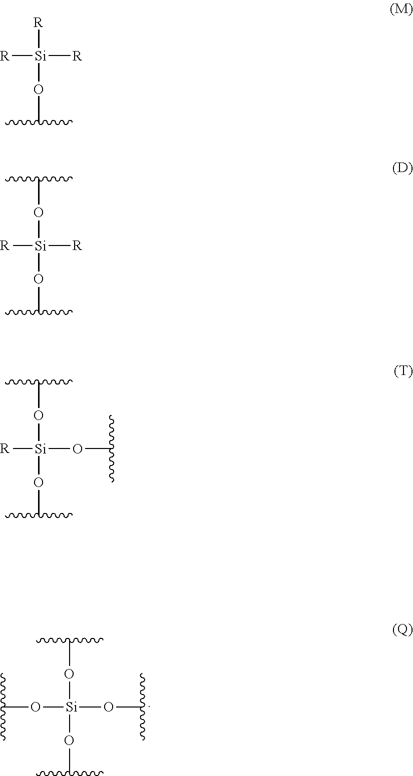

The term “hydrocarbon” as used herein refers to an organic group or molecule that includes carbon and hydrogen atoms. The term can also refer to an organic group or molecule that normally includes both carbon and hydrogen atoms but wherein all the hydrogen atoms are substituted with other organic groups.

The term “resin” as used herein refers to polysiloxane material of any viscosity that includes at least one siloxane monomer that is bonded via a Si—O—Si bond to three or four other siloxane monomers. In one example, the polysiloxane material includes T or Q groups, as defined herein.

The term “oligomer” as used herein refers to a molecule having an intermediate relative molecular mass, the structure of which essentially includes a small plurality of units derived, actually or conceptually, from molecules of lower relative molecular mass. A molecule having an intermediate relative mass can be a molecule that has properties that vary with the removal of one or a few of the units. The variation in the properties that results from the removal of the one of more units can be a significant variation.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “cure” as used herein refers to exposing to radiation in any form, heating, or allowing to undergo a chemical reaction that results in hardening or an increase in viscosity.

The term “pore” as used herein refers to a depression, slit, or hole of any size or shape in a solid object. A pore can run all the way through an object or partially through the object. A pore can intersect other pores.

The term “free-standing” or “unsupported” as used herein refers to a membrane with the majority of the surface area on each of the two major sides of the membrane not contacting a substrate, whether the substrate is porous or not. In some embodiments, a membrane that is “free-standing” or “unsupported” can be 100% not supported on both major sides. A membrane that is “free-standing” or “unsupported” can be supported at the edges or at the minority (e.g. less than about 50%) of the surface area on either or both major sides of the membrane.

The term “supported” as used herein refers to a membrane with the majority of the surface area on at least one of the two major sides contacting a substrate, whether the substrate is porous or not. In some embodiments, a membrane that is “supported” can be 100% supported on at least one side. A membrane that is “supported” can be supported at any suitable location at the majority (e.g. more than about 50%) of the surface area on either or both major sides of the membrane.

The term “enrich” as used herein refers to increasing in quantity or concentration, such as of a liquid, gas, or solute. For example, a mixture of gases A and B can be enriched in gas A if the concentration or quantity of gas A is increased, for example by selective permeation of gas A through a membrane to add gas A to the mixture, or for example by selective permeation of gas B through a membrane to take gas B away from the mixture.

The term “deplete” as used herein refers to decreasing in quantity or concentration, such as of a liquid, gas, or solute. For example, a mixture of gases A and B can be depleted in gas A if the concentration or quantity of gas A is decreased, for example by selective permeation of gas B through a membrane to take gas B away from the mixture, or for example by selective permeation of gas A through a membrane to add gas A to the mixture.

The term “solvent” as used herein refers to a liquid that can dissolve a solid, liquid, or gas. Nonlimiting examples of solvents are silicones, organic compounds, water, alcohols, ionic liquids, and supercritical fluids.

The term “siliceous” as used herein refers to any compound that includes a silicate or that includes silica.

The term “silicate” as used herein refers to any silicon-containing compound wherein the silicon atom has four bonds to oxygen, wherein at least one of the oxygen atoms bound to the silicon atom is ionic, such as any salt of a silicic acid. The counterion to the oxygen ion can be any other suitable ion or ions. An oxygen atom can be substituted with other silicon atoms, allowing for a polymer structure. One or more oxygen atoms can be double-bonded to the silicon atom; therefore, a silicate molecule can include a silicon atom with 2, 3, or 4 oxygen atoms. Examples of silicates include aluminum silicate. Zeolites are examples of materials that can include aluminum silicate. A silicate can be in the form of a salt, ion, or a neutral compound. In some embodiments, the term “silicate” does not include polymers.

The term “silica” as used herein refers to silicon dioxide (SiO₂).

The term “selectivity” as used herein refers to the ratio of permeability of the faster permeating gas over the slower permeating gas, measured at room temperature.

The term “permeability” as used herein refers the permeability coefficient (P_{X}) of substance X through a membrane, where q_{mX}=P_{X}*A*Δp_{X}*(1/delta), where q_{mX} is the mass flow of substance X through the membrane, A is the surface area of one major side of the membrane through which substance X flows, Δp_{X} is the pressure difference of the partial pressure of substance X across the membrane, and delta is the thickness of the membrane.

The term “Barrer” or “Barrers” as used herein refers to a unit of permeability, wherein 1 Barrer=10⁻¹¹ (cm³ gas) cm cm⁻² s⁻¹ mmHg⁻¹, or 10⁻¹⁰ (cm³ gas) cm cm⁻² s⁻¹ cmHg⁻¹, where “cm³ gas” represents the quantity of the gas that would take up one cubic centimeter at standard temperature and pressure.

This invention relates to silicone compositions that are useful for the production of membranes that are selectively permeable to at least one component of a gas mixture. The membrane includes a reaction product of a composition including an organopolysiloxane having at least two unsaturated aliphatic carbon-carbon bond-containing groups per molecule; a crosslinking agent having at least two silicon-bonded hydrogen atoms per molecule; a hydrosilylation catalyst; a polyether containing at least one unsaturated aliphatic carbon-carbon bond-containing group; and, a siliceous filler.

### Silicone Composition

The present invention provides a membrane that includes a reaction product of a silicone composition. Before curing (e.g. before the reaction product is formed), the silicone composition of the present invention includes an organopolysiloxane having at least two unsaturated aliphatic carbon-carbon bond-containing groups per molecule; a crosslinking agent having at least two silicon-bonded hydrogen atoms per molecule; a hydrosilylation catalyst; a polyether containing at least one unsaturated aliphatic carbon-carbon bond-containing group; and, a siliceous filler.

In some examples, the organopolysiloxane having at least two unsaturated aliphatic carbon-carbon bond-containing groups per molecule can be present in from about 5 wt % to about 99 wt %, about 15 wt % to about 98 wt %, or about 25 wt % to about 95 wt % of the uncured composition. In some embodiments, the organopolysiloxane having at least two unsaturated aliphatic carbon-carbon bond-containing groups per molecule can be present in from about 15 wt % to about 80 wt %, about 20 wt % to about 70 wt %, or about 25 wt % to about 60 wt % of the uncured composition. In some embodiments, the organopolysiloxane having at least two unsaturated aliphatic carbon-carbon bond-containing groups per molecule can be present in from about 40 wt % to about 99 wt %, about 50 wt % to about 98 wt %, or about 60 wt % to about 95 wt % of the uncured composition. Wt % in this paragraph refers to the percent by weight based on the total weight of the uncured composition.

In some examples, the organosilicon compound having an average of at least two silicon-bonded hydrogen atoms per molecule (crosslinking agent) can be present in from about 1 wt % to about 20 wt %, about 0.5 wt % to about 30 wt %, or about 0.1 wt % to about 40 wt % of the uncured composition. In some embodiments, the crosslinking agent having at least two silicon-bonded hydrogen atoms per molecule can be present in from about 1.5 wt % to about 6 wt %, about 1.0 wt % to about 10 wt %, or about 0.5 wt % to about 20 wt % of the uncured composition. In some embodiments, the crosslinking agent having at least two silicon-bonded hydrogen atoms per molecule can be present in from about 6 wt % to about 14 wt %, about 3 wt % to about 20 wt %, or about 1 wt % to about 30 wt % of the uncured composition. Wt % in this paragraph refers to the percent by weight based on the total weight of the uncured composition.

In some examples, the hydrosilylation catalyst can be present in from about 0.05 wt % to about 1.5 wt %, about 0.01 wt % to about 3 wt %, or about 0.001 wt % to about 6 wt % of the uncured composition. In some embodiments, the hydrosilylation catalyst can be present in from about 0.1 wt % to about 0.3 wt %, about 0.05 wt % to about 0.6 wt %, or about 0.01 wt % to about 1.2 wt % of the uncured composition. In some embodiments, the hydrosilylation catalyst can be present in from about 0.2 wt % to about 1.5 wt %, about 0.1 wt % to about 3 wt %, or about 0.05 wt % to about 6 wt % of the uncured composition. Wt % in this paragraph refers to the percent by weight based on the total weight of the uncured composition. In some embodiments, the hydrosilylation catalyst can include platinum. In some embodiments, the uncured composition can include about 0.01 to about 2000 ppm Pt (w/w), about 0.1 to about 1000 ppm Pt, about 3 to about 100 ppm Pt, or about 5 to about 50 ppm Pt, based on the total weight of the uncured composition.

The polyether containing at least one unsaturated aliphatic carbon-carbon bond-containing group can be present in from about 5 wt % to about 40 wt %, about 2 wt % to about 60 wt %, or about 0.5 wt % to about 80 wt % of the uncured composition. In some embodiments, the polyether containing at least one unsaturated aliphatic carbon-carbon bond-containing group can be present in from about 15 wt % to about 25 wt %, about 10 wt % to about 35 wt %, or about 5 wt % to about 45 wt % of the uncured composition. In some embodiments, the polyether containing at least one unsaturated aliphatic carbon-carbon bond-containing group can be present in from about 10 wt % to about 15 wt %, about 5 wt % to about 25 wt %, or about 1 wt % to about 40 wt % of the uncured composition. Wt % in this paragraph refers to the percent by weight based on the total weight of the uncured composition.

The siliceous filler can be present in from about 5 wt % to about 40 wt %, about 1 wt % to about 60 wt %, or about 0.1 wt % to about 80 wt % of the uncured composition. In some embodiments, the siliceous filler can be present in from about 25 wt % to about 40 wt %, about 15 wt % to about 50 wt %, or about 10 wt % to about 60 wt % of the uncured composition. In some embodiments, the siliceous filler can be present in from about 5 wt % to about 25 wt %, about 2.5 wt % to about 35 wt %, or about 1 wt % to about 45 wt % of the uncured composition. Wt % in this paragraph refers to the percent by weight based on the total weight of the uncured composition.

Curing the composition of the present invention to provide a cured composition can cause ingredients of the uncured composition to combine or otherwise chemically react to give different chemical compounds than those identified as being part of the uncured composition. In some embodiments, some proportion of the ingredients of the uncured composition do not combine or otherwise chemically react. In other embodiments, all or most of the ingredients of the uncured composition combine or otherwise chemically react.

In making the composition, the components can be mixed by any method of mixing known to one of skill in the art. One method to mix is, for example, using a mixer. The mixer used is not specifically restricted and can be determined by the viscosity of the components and the composition. Suitable mixers include but are not limited to kneader type sigma blade mixers, double planetary mixers, non-intrusive mixers such as those reliant on centrifugal motion, and two-and three-roll rubber mills. One skilled in the art would be able to prepare the composition without undue experimentation by the methods disclosed above and in the examples set forth below.

The composition may be a one-part composition or a multiple-part composition such as a two-part composition. In a multiple-part composition, any one of more of the can be stored in separate parts. Any of the components can be added to either or both parts. When a multiple part composition is prepared, it may be marketed as a kit. The kit may further include information or instructions or both as how to use the kit, how to combine the parts, or how to cure the resulting combination, or combinations thereof.

### Membrane

In one embodiment, the present invention provides a membrane that includes a reaction product of a silicone composition, wherein the silicone composition includes a polyether containing at least one unsaturated aliphatic carbon-carbon bond-containing group and a siliceous filler. In another embodiment, the present invention provides a method of forming a membrane. The present invention can include the step of forming a membrane. The membrane can be formed on at least one surface of a substrate. For any membrane to be considered “on” a substrate, the membrane can be attached (e.g. adhered) to the substrate, or be otherwise in contact with the substrate without being adhered. The substrate can have any surface texture, and can be porous or non-porous. The substrate can include surfaces that are not coated with a membrane by the step of forming a membrane. All surfaces of the substrate can be coated by the step of forming a membrane, one surface can be coated, or any number of surfaces can be coated.

The step of forming a membrane can include two steps. In the first step, the composition that forms the membrane can be applied to at least one surface of the substrate. In the second step, the applied composition that forms the membrane can be cured to form the membrane. In some embodiments, the curing process of the composition can begin before, during, or after application of the composition to the surface. The curing process transforms the composition that forms the membrane into the membrane. The composition that forms the membrane can be in a liquid state. The membrane can be in a solid state.

The composition that forms the membrane can be applied using conventional coating techniques, for example, immersion coating, spin coating, dipping, spraying, brushing, roll coating, extrusion, screen-printing, pad printing, or inkjet printing.

Curing the composition that forms the membrane can include the addition of a curing agent or initiator such as, for example, a hydrosilylation catalyst. In some embodiments, the curing process can begin immediately upon addition of the curing agent or initiator. The addition of the curing agent or initiator may not begin the curing process immediately, and can require additional curing steps. In other embodiments, the addition of the curing agent or initiator can begin the curing process immediately, and can also require additional curing steps. The addition of the curing agent or initiator can begin the curing process, but not bring it to a point where there composition is cured to the point of being fully cured, or of being unworkable. Thus, the curing agent or initiator can be added before or during the coating process, and further processing steps can complete the cure to form the membrane.

Curing the composition that forms the membrane can include a variety of methods, including exposing the composition to ambient temperature, elevated temperature, moisture, or radiation. In some embodiments, curing the composition can include combination of methods.

The membrane of the present invention can have any suitable thickness. In some examples, the membrane has a thickness of from about 1 μm to about 20 μm. In some examples, the membrane has a thickness of from about 0.1 μm to about 200 μm. In other examples, the membrane has a thickness of from about 0.01 μm to about 2000 μm.

The membrane of the present invention can be selectively permeable to one substance over another. In one example, the membrane is selectively permeable to one gas over other gases or liquids. In another example, the membrane is selectively permeable to more than one gas over other gases or liquids. In one embodiment, the membrane is selectively permeable to one liquid over other liquids or gases. In another embodiment, the membrane is selectively permeable to more than one liquid over other liquids. In some examples, the membrane has an ideal CO₂/N₂ selectivity of at least about 9, at least about 11, at least about 13, at least about 15, or at least about 20. In some examples, the membrane has a CO₂/CH₄ selectivity of at least about 3, at least about 5, at least about 7, or at least about 9. In another example, the membrane has a CO₂/N₂ selectivity of at least about 12, 13, 15, or at least about 16. In some embodiments, with a CO₂/N₂ mixture for example, the membrane has a CO₂ permeability coefficient of at least about 300 Barrers, 1300, 1400, 1800, 1900, 2100, 2400, 2500, 2700, 2800, 3000, 3200, or about 4000 Barrers. In one example, the membrane can have a CO₂ permeability greater than about 3000 Barrers and a CO₂/N₂ selectivity of greater than about 10; in some embodiments, for example, such a membrane can be formed from a composition that includes an alkenyl-functional polydimethylsiloxane/MQ-containing polysiloxane resin, and ground quartz. In one example, the membrane can have a CO₂ permeability greater than about 300 Barrers and a CO₂/CH₄ selectivity of greater than about 3; in some embodiments, for example, such a membrane can be formed from a composition that includes an alkenyl-functional fluorosilicone and mica.

The membrane of the present invention can have any suitable shape. In some examples, the membrane of the present invention is a plate-and-frame membrane, a spiral wound membrane, a tubular membrane, a capillary fiber membrane or a hollow fiber membrane. The membrane can be a continuous or discontinuous layer of material. In some embodiments, the membrane may be used in conjunction with a liquid that enhances gas transport, such as in a membrane contactor (e.g. a device that permits mass transfer between a gaseous phase and a liquid phase across a membrane without dispersing the phases in one another).

### Supported Membrane

In some embodiments of the present invention, the membrane is supported on a porous or highly permeable non-porous substrate. A supported membrane has the majority of the surface area of at least one of the two major sides of the membrane contacting a porous or highly permeable non-porous substrate. A supported membrane on a porous substrate can be referred to as a composite membrane, where the membrane is a composite of the membrane and the porous substrate. The porous substrate on which the supported membrane is located can allow gases to pass through the pores and to reach the membrane. The supported membrane can be attached (e.g. adhered) to the porous substrate. The supported membrane can be in contact with the substrate without being adhered. The porous substrate can be partially integrated, fully integrated, or not integrated into the membrane.

A coating can be formed on the at least one porous surface of the substrate or on the at least one surface of the highly permeable non-porous substrate. Alternately, a porous or highly permeable non-porous substrate can be placed in contact with the formed coating before, during, or after curing of the coating. In some examples, a porous substrate can have its pores filled at the surface to provide a smooth surface for formation of a membrane; after formation of the membrane, the composition filling the pores can be dried or otherwise removed or shrunk to restore the porosity of the substrate. In some examples, the supported membrane is made in a manner identical to that disclosed herein pertaining to a free-standing membrane, but with the additional step of placing or adhering the free-standing membrane on a porous substrate to make a supported membrane.

The porous substrate can be any suitable porous material known to one of skill in the art, in any shape. For example, the substrate can be a filter. The porous substrate can be woven or non-woven. The porous substrate can be a frit, a porous sheet, or a porous hollow fiber. For example, the at least one surface can be flat, curved, or any combination thereof. The surface can have any perimeter shape. The porous substrate can have any number of surfaces, and can be any three-dimensional shape. Examples of three-dimensional shapes include cubes, spheres, cones, and planar sections thereof with any thickness, including variable thicknesses. The porous substrate or highly permeable non-porous substrate can be smooth, be corrugated or patterned, or have any amount of surface roughness. The porous substrate can have any number of pores, and the pores can be of any size, depth, shape, and distribution. In one example, the porous substrate has a pore size of from about 0.2 nm to about 500 μm. The at least one surface can have any number of pores. In some examples, the pore size distribution may be asymmetric across the thickness of the porous sheet, film or fiber.

Suitable examples of porous substrates include porous polymeric films, fibers or hollow fibers, or porous polymers or any suitable shape or form. Examples of polymers that can form porous polymers suitable for use as a porous substrate in embodiments of the present invention include those disclosed in U.S. Pat. No. 7,858,197. For example, suitable polymers include polyethylene, polypropylene, polysulfones, polyamides, polyether ether ketone (PEEK), polyarylates, polyaramides, polyethers, polyarylethers, polyimides, polyetherimides, polyphthalamides, polyesters, polyacrylates, polymethacrylates, cellulose acetate, polycarbonates, polyacrylonitrile, polytetrafluoroethylene and other fluorinated polymers, polyvinylalcohol, polyvinylacetate, syndiotactic or amorphous polystyrene, Kevlar™ and other liquid crystalline polymers, epoxy resins, phenolic resins, polydimethylsiloxane elastomers, silicone resins, fluorosilicone elastomers, fluorosilicone resins, polyurethanes, and copolymers, blends or derivatives thereof Suitable porous substrates can include, for example, porous glass, various forms and crystal forms of porous metals, ceramics and alloys, including porous alumina, zirconia, titania, and steel.

### Free-Standing Membrane

In some embodiments of the present invention, the membrane is unsupported, also referred to as free-standing. The majority of the surface area on each of the two major sides of a membrane that is free-standing is not contacting a substrate, whether the substrate is porous or not. In some embodiments, a membrane that is free-standing can be 100% unsupported. A membrane that is free-standing can be supported at the edges or at the minority (e.g. less than 50%) of the surface area on either or both major sides of the membrane. The support for a free-standing membrane can be a porous substrate or a nonporous substrate. Examples of suitable supports for a free-standing membrane can include any examples of supports given in the above section Supported Membrane. A free-standing membrane can have any suitable shape, regardless of the percent of the free-standing membrane that is supported. Examples of suitable shapes for free-standing membranes include, for example, squares, rectangles, circles, tubes, cubes, spheres, cones, and planar sections thereof, with any thickness, including variable thicknesses.

A support for a free-standing membrane can be attached to the membrane in any suitable manner, for example, by clamping, with use of adhesive, by melting the membrane to the edges of the substrate, or by chemically bonding the membrane to the substrate by any suitable means. The support for the free-standing membrane can be not attached to the membrane but in contact with the membrane and held in place by friction or gravity. The support can include, for example, a frame around the edges of the membrane, which can optionally include one or more cross-beam supports within the frame. The frame can be any suitable shape, including a square or circle, and the cross-beam supports, if any, can form any suitable shape within the frame. The frame can be any suitable thickness. The support can be, for example, a cross-hatch pattern of supports for the membrane, where the cross-hatch pattern has any suitable dimensions.

In some embodiments, a free-standing membrane is made by the steps of coating or applying a composition onto a substrate, curing the composition, and partially or fully removing the membrane from the substrate. After application of the composition to the substrate, the assembly can be referred to as a laminated film or fiber. During or after the curing process the membrane can be at least partially removed from at least one substrate. In some examples, after the unsupported membrane is removed from a substrate, and the unsupported membrane is attached to a support, as described above. In some examples, an unsupported membrane is made by the steps of coating a composition onto one or more substrates, curing the composition, and removing the membrane from at least one of the one or more substrates, while leaving at least one of the one of more substrates in contact with the membrane. In some embodiments, the membrane is entirely removed from the substrate. In one example, the membrane can be peeled away from the substrate. In one example, the substrate can be removed from the membrane by melting, subliming, chemical etching, or dissolving in a solvent. In one example, the substrate is a water soluble polymer that is dissolved by purging with water. In one example, the substrate is a fiber or hollow fiber, as described in U.S. Pat. No. 6,797,212 B2.

In examples that include a substrate, the substrate can be porous or nonporous. The substrate can be any suitable material, and can be any suitable shape, including planar, curved, solid, hollow, or any combination thereof. Suitable materials for porous or nonporous substrates include any materials described above as suitable for use as porous substrates in supported membranes, as well as any suitable less-porous materials. In some examples, the membrane can be heated, cooled, washed, etched or otherwise treated to facilitate removal from the substrate. In other examples, air pressure can be used to facilitate removal of the membrane from the substrate.

Organopolysiloxane Having an Average of at least Two Silicon-Bonded Unsaturated Aliphatic Carbon-Carbon Bond-Containing Groups per Molecule

The silicone composition in its pre-cured state includes an organopolysiloxane having an average of at least two silicon-bonded unsaturated aliphatic carbon-carbon bond-containing groups per molecule, alternatively at least three silicon-bonded unsaturated aliphatic carbon-carbon bond-containing groups per molecule. The organopolysiloxane can be present in an amount sufficient to allow curing of the silicone composition. The organopolysiloxane can have a linear or branched structure. The organopolysiloxane compound can be a homopolymer or a copolymer. The organopolysiloxane compound can be a disiloxane, trisiloxane, or polysiloxane. The structure of the organopolysiloxane compound can be linear, branched, cyclic, or resinous. Cyclosiloxanes can have from 3 to 12 silicon atoms, alternatively from 3 to 10 silicon atoms, alternatively from 3 to 5 silicon atoms. In acyclic organopolysiloxanes, the silicon-bonded unsaturated aliphatic carbon-carbon bond-containing groups can be located at terminal, pendant, or at both terminal and pendant positions.

The organopolysiloxane compound can be a single polyorganosiloxane or a combination including two or more polyorganosiloxanes that differ in at least one of the following properties: structure, viscosity, average molecular weight, siloxane units, and sequence.

Examples of aliphatic unsaturated carbon-carbon bond-containing groups can include alkenyl groups such as vinyl, allyl, butenyl, and hexenyl; alkynyl groups such as ethynyl, propynyl, and butynyl; or acrylate-functional groups such as acryloyloxyalkyl or methacryloyloxypropyl.

The organopolysiloxane having an average of at least two silicon-bonded unsaturated aliphatic carbon-carbon bond-containing groups per molecule can include a polyorganosiloxane of the formula

R^{y}₃SiO(R^{y}₂SiO)_{α}(R^{y}R²SiO)_{β}SiR^{y}₃, (a)

R^{y}₂R⁴SiO(R^{y}₂SiO)_{χ}(R^{y}R⁴SiO)_{δ}SiR^{y}₂R⁴, (b)

or combinations thereof.

In formula (a), α has an average value of 0 to 2000, and β has an average value of 1 to 2000. Each R^{y} is is independently halogen, hydrogen, or an organic group such as acrylate; alkyl; alkoxy; halogenated hydrocarbon; alkenyl; alkynyl; aryl; heteroaryl; and cyanoalkyl. Each R² is independently an unsaturated aliphatic carbon-carbon bond-containing group, as described herein.

In formula (b), χ has an average value of 0 to 2000, and δ has an average value of 1 to 2000. Each R^{y} is independently as defined above, and R⁴ is independently the same as defined for R² above.

The organopolysiloxane having an average of at least two silicon-bonded unsaturated aliphatic carbon-carbon bond-containing groups per molecule can include a polyorganosiloxane of the formula

(R¹R²R³SiO_{1/2})ₐ(R⁴R⁵SiO_{2/2})_{b}(R⁶SiO_{3/2})_{c}(SiO_{4/2})_{d} (I)

wherein each of R¹, R², R³, R⁴, R⁵, and R⁶ is an organic group independently selected from R^{y} as defined herein, 0≦a<0.95, 0≦b<1, ≦c<1, 0≦d<0.95, a+b+c+d=1.

The organopolysiloxane having an average of at least two silicon-bonded unsaturated aliphatic carbon-carbon bond-containing groups per molecule can be a single organosilicon compound or a mixture including two or more different organosilicon compounds, each as described herein. For example the organopolysiloxane can be a single organosilane, a mixture of two different organosilanes, a single organosiloxane, a mixture of two different organosiloxanes, or a mixture of an organosilane and an organosiloxane.

In some examples, the organopolysiloxane having an average of at least two silicon-bonded unsaturated aliphatic carbon-carbon bond-containing groups per molecule can include a dimethylvinyl-terminated dimethyl siloxane, dimethylvinylated and trimethylated silica, tetramethyl tetravinyl cyclotetrasiloxane, dimethylvinylsiloxy-terminated polydimethylsiloxane, trimethylsiloxy-terminated polydimethylsiloxane-polymethylvinylsiloxane copolymer, dimethylvinylsiloxy-terminated polydimethylsiloxane-polymethylvinylsiloxane copolymer, or tetramethyldivinyldisiloxane. In some examples, the vinyl groups of the structures in the preceding list can be substituted with allyl, hexenyl, acrylic, methacrylic or other hydrosilylation-reactive unsaturated groups. In some examples, the organopolysiloxane can include an organopolysiloxane resin consisting essentially of CH₂═CH(CH₃)₂SiO_{1/2}units, (CH₃)₃SiO_{1/2} units, and SiO_{4/2} units, PhSi(OSiMe₂Vi)₃, Si(OSiMe₂Vi)₄, MeSi(OSiMe₂Vi)₃, and Ph₂Si(OSiMe₂Vi)₂, where Me is methyl, Ph is phenyl, and Vi is vinyl, and combinations thereof In some examples, the organopolysiloxane can include an oligomeric dimethylsiloxane(D)-methylvinylsiloxane(D^{Vi}) diol.

The organopolysiloxane having an average of at least two silicon-bonded unsaturated aliphatic carbon-carbon bond-containing groups per molecule can be a single organopolysiloxane compound or a mixture including two or more different organopolysiloxane compounds, each as described above. For example the organopolysiloxane can include a single organopolysiloxane, or a mixture of two different organopolysiloxanes that differ in at least one of the following properties: structure, average molecular weight, viscosity, siloxane units, and sequence.

In the uncured composition, the concentration of unsaturated aliphatic carbon-carbon bond-containing groups, including those from the organopolysiloxane having an average of at least two silicon-bonded unsaturated aliphatic carbon-carbon bond-containing groups per molecule, can be sufficient to cure (e.g. cross-link) the silicone composition. The exact amount of the unsaturated groups depends on the desired extent of cure, which generally increases as the ratio of the number of moles of unsaturated groups to the number of moles of silicon-bonded hydrogen atoms in the organosilicon compound having an average of at least two silicon-bonded hydrogen atoms per molecule increases. In some embodiments of the present invention, in the pre-cured composition, the molar ratio of silicon-bonded hydrogen atoms to the total number of unsaturated groups (including those from silicon-bonded unsaturated aliphatic carbon-carbon bond-containing groups, polyethers with at least one alkenyl group, cure modifiers, or any other compound that includes an unsaturated C—C bond-containing group) can be, for example, about 0.3:1 to about 5:1, about 0.5:1 to about 3:1, about 0.8:1 to about 2:1, about 0.9:1 to about 1.8:1, or 1:1 to about 1.5:1.

Organosilicon Compound Having an Average of at least Two Silicon-Bonded Hydrogen Atoms per Molecule

The silicone composition in its pre-cured state includes an organosilicon compound having an average of at least two silicon-bonded hydrogen atoms per molecule, alternatively at least three silicon-bonded hydrogen atoms per molecule. The organosilicon compound can be present in a sufficient quantity to allow curing of the silicone composition. In some embodiments the organosilicon compound having an average of at least two silicon-bonded hydrogen atoms per molecule can be an organohydrogenpolysiloxane, for example a siloxane dimer, oligomer, or polymer. In some embodiments the organosilicon compound having an average of at least two silicon-bonded hydrogen atoms per molecule is an organohydrogensilane. The organosilicon compound can be a homopolymer or a copolymer. The organosilicon compound can have a linear, branched, cyclic, or resinous structure. The silicon-bonded hydrogen atoms in the organosilicon compound can be located at terminal, pendant, or at both terminal and pendant positions. The organosilicon compound can be free of fluorine atoms. The organosilicon compound can function as a cross-linker when the composition is cured, for example via hydrosilylation.

In some embodiments, the organosilicon compound can be an organohydrogensilane or an organohydrogensiloxane. The organohydrogensilane can be a monosilane, disilane, trisilane, or polysilane. Similarly, the organohydrogensiloxane can be a disiloxane, trisiloxane, or polysiloxane. The structure of the organosilicon compound can be linear, branched, cyclic, or resinous. Cyclosilanes and cyclosiloxanes can have from 3 to 12 silicon atoms, alternatively from 3 to 10 silicon atoms, alternatively from 3 to 4 silicon atoms. In acyclic polysilanes and polysiloxanes, the silicon-bonded hydrogen atoms can be located at terminal, pendant, or at both terminal and pendant positions.

Examples of suitable organosilanes can include diphenylsilane, 2-chloroethylsilane, bis[(p-dimethylsilyl)phenyl]ether, 1,4-dimethyldisilylethane, 1,3,5-tris(dimethylsilyl)benzene, 1,3,5-trimethyl-1,3,5-trisilane, poly(methylsilylene)phenylene, and poly(methylsilylene)methylene. In some examples, the organohydrogensilane can have the formula HR¹₂Si—R²—SiR¹₂H, wherein R¹ is C₁ to C₁₀ hydrocarbyl or C₁ to C₁₀ halogen-substituted hydrocarbyl, both free of aliphatic unsaturation, and R² is a hydrocarbylene group free of aliphatic unsaturation having a formula selected from 1,4- or 1,3-disubstituted phenyl, 4,4′- or 3,3′-disubstituted-1,1′-biphenyl, or para- or meta-disubstituted Ph(C_{g}H_{2g})Ph.

In one example, an organohydrogenpolysiloxane can include a compound of the formula

R^{x}₃SiO(R^{x}₂SiO)_{α}(R^{x}R²SiO)_{β}SiR^{x}₃, or (a)

R⁴R^{x}₂SiO(R^{x}₂SiO)_{χ}(R^{x}R⁴SiO)_{δ}SiR^{x}₂R⁴. (b)

In formula (a), α has an average value of about 0 to about 500,000, and β has an average value of about 2 to about 500,000, provided the organohydrogenpolysiloxane has an average of at least two silicon-bonded hydrogen atoms per molecule. Each R^{x} is independently halogen, or an organic group such as acrylate; alkyl; alkoxy; halogenated hydrocarbon; alkenyl; alkynyl; aryl; heteroaryl; and cyanoalkyl. Each R² is independently H or R^{x}. In some embodiments, β is less than about 20, is at least 20, 40, 150, or is greater than about 200.

In formula (b), x has an average value of 0 to 500,000, and δ has an average value of 0 to 500,000, provided the organohydrogenpolysiloxane has an average of at least two silicon-bonded hydrogen atoms per molecule. Each R^{x} is independently as described above. Each R⁴ is independently H or R^{x}. In some embodiments, δ is less than about 20, is at least 20, 40, 150, or is greater than about 200.

Examples of organohydrogenpolysiloxanes can include compounds having the average unit formula

(R^{x}R⁴R⁵SiO_{1/2})_{w}(R^{x}R⁴SiO_{2/2})ₓ(R⁴SiO_{3/2})_{y}(SiO_{4/2})_{z} (I),

wherein each R^{x} is independently as defined above, R⁴ is H or R^{x}, R⁵ is H or R^{x}, 0≦w<0.95, 0≦x<1, 0≦y<1, 0≦z<0.95, and w+x+y+z≈1, provided the organohydrogenpolysiloxane has an average of at least two silicon-bonded hydrogen atoms per molecule. In some embodiments, R¹ is C₁₋₁₀ hydrocarbyl or C₁₋₁₀ halogen-substituted hydrocarbyl, both free of aliphatic unsaturation, or C₄ to C₁₄ aryl. In some embodiments, w is from 0.01 to 0.6, x is from 0 to 0.5, y is from 0 to 0.95, z is from 0 to 0.4, and w+x+y+z≈1.

Examples of organohydrogensiloxanes can include, for example, 1,1,3,3-tetramethyldisiloxane, 1,1,3,3-tetraphenyldisiloxane, phenyltris(dimethylsiloxy)silane, 1,3,5-trimethylcyclotrisiloxane, a trimethylsiloxy-terminated poly(methylhydrogensiloxane), a trimethylsiloxy-terminated poly(dimethylsiloxane/methylhydrogensiloxane), a dimethylhydrogensiloxy-terminated poly(methylhydrogensiloxane), a methylhydrogensiloxy-terminated polydimethylsiloxane, dimethylhydrogensiloxy-terminated poly(dimethylsiloxane/methylhydrogensiloxane), and combinations thereof. In some examples, the organohydrogenpolysiloxane typically has a number-average molecular weight (Mₙ) of about 500 to 50,000, or about 1000 to 20,000, or about 2,000 to 10,000, where the molecular weight can be determined by gel permeation chromatography employing a refractive index detector and polydimethylsiloxane standards. The organosilicon compound can be a combination of two or more organohydrogensilanes or organohydrogenpolysiloxanes that differ in at least one of the following properties: structure, average molecular weight, viscosity, siloxane units, and sequence.

The molar ratio of silicon-bonded hydrogen atoms in the organosilicon compound having an average of at least two silicon-bonded hydrogen atoms per molecule to aliphatically unsaturated groups in the organopolysiloxane having an average of at least two silicon-bonded unsaturated aliphatic carbon-carbon bond-containing groups per molecule (SiH/Vi) is not critical. However, the components in the composition may be selected such that the molar ratio of the total number of silicon-bonded hydrogen atoms to aliphatically unsaturated groups in the composition (SiHₜₒₜ/Viₜₒₜ) is greater than 0.5, alternatively at least 0.9, alternatively at least 1.0, and alternatively at least about 1.05. SiHₜₒₜ/Viₜₒₜ may be up to about 10.0, alternatively up to about 5.0, and alternatively up to about 3.0. Without wishing to be bound by theory, it is thought that if SiHₜₒₜ/Viₜₒₜ is too low, then the composition may not cure or may not adhere to some substrates. Without wishing to be bound by theory, it is thought that if SiHₜₒₜ/Viₜₒₜ is too high, surface properties such as adhesion may be hindered and there may be an increase in bleed from within the formulation to other surfaces.

Polyether Having at least One Saturated Aliphatic Carbon-Carbon Bond-Containing Group per Molecule

The silicone composition in its pre-cured state includes at least one polyether having at least one unsaturated aliphatic carbon-carbon bond-containing group per molecule. The polyether can be any poly(alkylene oxide) having at least one unsaturated aliphatic carbon-carbon bond-containing group per molecule.

In one example, the polyether is a polyalkylene glycol. A suitable polyether molecule can include both unsubstituted and substituted alkylene units. One or more alkylene units can include an alkenyl substituent. The polyalkylene glycol can include alkylene units of any suitable length, including C₁₋₂₀. The alkylene units can be the same throughout a molecule, or can vary in a molecule. In polyether molecules that include varying alkylene units, the variation can follow a pattern, or can be random. The alkylene units can be branched or linear, and some examples can have both branched and unbranched alkylene units. In some examples, the alkylene units can be unsubstituted. In other examples, one or more of the alkylene units can be substituted with any suitable functional group.

In one example, the polyether can include one or more alkenylene or alkynylene units of any suitable length, including C₂₋₂₀. In some examples, the unsaturation of such polyethers can occur between two of the carbon atoms in an alkylene unit that directly connects one oxygen atom to another. In some examples, a polyether that includes alkenylene or alkynylene units can include an alkenyl substituent as an alternative or addition to unsaturation in an alkylene unit that directly connects one oxygen atom to another. Polyethers that include one or more alkenylene or alkynylene units can also include one or more substituted or unsubstituted alkylene units, in random or ordered pattern.

The polyether can be substituted at its ends with any suitable functional group. In one example, the polyether is substituted on at least end with a hydrogen atom (H), forming a hydroxyl group. In one example, the polyether can be substituted on at least one end with an alkyl substituent. In some examples, the polyether is substituted on one or both ends with an alkyl group that corresponds to the alkylene units included in the polyether. For example, a polyethylene glycol can be substituted at one or both ends with an ethyl substituent. In other examples, the polyether is substituted at one or both ends with a group that does not correspond to the alkylene units included in the polyether. For example, a polypropylene glycol can be substituted at one or more ends with an acetyl substituent, forming an acetate at one or more ends of the polyalkylene glycol; such a polyether can be referred to as an acetate terminated polyether. In another example, a polypropylene glycol can be substituted at one or more ends with an ethyl substituent. In some examples, the polyether is substituted on at least one end with an alkenyl substituent; in the case of a propylenyl substituent, such a polyether can be referred to as an allyl terminated polyether; in the case of an ethylenyl substituent, such a polyether can be referred to as a vinyl terminated polyether.

In some embodiments, the polyether has the formula

R⁴(OR⁶)ₑOR¹ (III),

wherein R¹ is hydrogen or an organic group independently selected from any optionally further substituted C₁₋₁₅ organic group, including C₁₋₁₅ monovalent aliphatic hydrocarbon groups, C₄₋₁₅ monovalent aromatic hydrocarbon groups, and monovalent epoxy-substituted organic groups, R⁴ is C₂ to C₁₁ alkenyl (e.g. ethenyl, propenyl, butenyl, hexenyl, octenyl, undecylenyl), R⁶ is a linear or branched optionally substituted C₁₋₁₀ alkylene unit, e is from about 1 to about 10,000, wherein R₆ is independently selected (e.g. can be the same or different) for each alkylene unit (e.g. each alkylene oxide unit) of the polyether. In some embodiments, R¹ is acetyl (Ac). In some embodiments, R⁶ is a halogen substituted linear or branched C₁₋₁₀ alkylene unit.

### Siliceous Filler

The silicone composition in its pre-cured state includes a siliceous filler. Examples of siliceous fillers include various forms of silicas and silicates, including metallosilicates, fumed silica, colloidal silica, precipitated silica, diatomaceous silica, silica gel, quartz, crystalline quartz, fused quartz, mica, zeolites, and clay. In one example, the filler is ground quartz. Suitable siliceous fillers encompass any form of the filler, including fibrous, granular or powder form, including nanoparticles.

### Hydrosilylation Catalyst

The silicone composition in its pre-cured state includes at least one hydrosilylation catalyst. During curing of the silicone composition, the hydrosilylation catalyst can catalyze an addition reaction (hydrosilylation) of the organosilicon compound having an average of at least two silicon-bonded hydrogen atoms per molecule with the organopolysiloxane having an average of at least two silicon-bonded unsaturated aliphatic carbon-carbon bond-containing groups per molecule. In some embodiments, the hydrosilylation catalyst can be any hydrosilylation catalyst including a platinum group metal or a compound containing a platinum group metal. Platinum group metals include platinum, rhodium, ruthenium, palladium, osmium and iridium. Typically, the platinum group metal is platinum, based on its high activity in hydrosilylation reactions.

Examples of hydrosilylation catalysts include the complexes of chloroplatinic acid and certain vinyl-containing organosiloxanes disclosed by Willing in U.S. Pat. No. 3,419,593, such as the reaction product of chloroplatinic acid and 1,3-divinyl-1,1,3,3-tetramethyldisiloxane; microencapsulated hydrosilylation catalysts including a platinum group metal encapsulated in a thermoplastic resin, as exemplified in U.S. Pat. No. 4,766,176 and U.S. Pat. No. 5,017,654; and photoactivated hydrosilylation catalysts, such as platinum(II) bis(2,4-pentanedioate), as exemplified in U.S. Pat. No. 7,799,842. An example of a suitable hydrosilylation catalyst includes a platinum(IV) complex of 1,3-diethenyl-1,1,3,3-tetramethyldisiloxane.

The at least one hydrosilylation catalyst can be a single hydrosilylation catalyst or a mixture including two or more different catalysts that differ in at least one property, such as structure, form, platinum group metal, complexing ligand, or thermoplastic resin.

### Optional Ingredients

The silicone composition can optionally include any suitable ingredient; the possible optional ingredients are not limited to those described herein.

Cure inhibitors can optionally be added to the silicone compositions. Any suitable platinum group type inhibitor can be used. Nonlimiting suitable platinum catalyst inhibitors include acetylenic inhibitors, olefinic siloxanes and polymethylvinylcyclosiloxanes having three to six methylvinylsiloxane units per molecule. Examples of acetylenic inhibitors can include acetylenic alcohols, such as 2-methyl-3-butyn-2-ol or 1-ethynyl-2-cyclohexanol which can suppress the activity of a platinum-based catalyst at 25° C. The amount of inhibitor present in the silicone compositions contemplated herein can range from about 0 to about 0.1% (by weight) and in other embodiments can range up to about 0.5% (by weight) based on the amount by total weight of components in the composition.

One or more solvents can be optionally added to the silicone composition, for example to lower the viscosity of the composition.

### Method of Separation of Gases

The present invention also provides a method of separating gas components or water vapor in a feed gas mixture by use of the membrane described herein. The method includes contacting a first side of a membrane with a feed gas mixture to produce a permeate gas mixture on a second side of the membrane and a retentate gas mixture on the first side of the membrane. The permeate gas mixture is enriched in the first gas component. The retentate gas mixture is depleted in the first gas component. The membrane can include any suitable membrane as described herein.

The membrane can be free-standing or supported by a porous or permeable substrate. In some embodiments, the pressure on either side of the membrane can be about the same. In other embodiments, there can be a pressure differential between one side of the membrane and the other side of the membrane. For example, the pressure on the retentate side of the membrane can be higher than the pressure on the permeate side of the membrane. In other examples, the pressure on the permeate side of the membrane can be higher than the pressure on the retentate side of the membrane.

The feed gas mixture can include any mixture of gases. For example, the feed gas mixture can include hydrogen, carbon dioxide, nitrogen, ammonia, methane, water vapor, hydrogen sulfide, or any combination thereof The feed gas can include any gas known to one of skill in the art. The membrane can be selectively permeable to any one gas in the feed gas, or to any of several gases in the feed gas. The membrane can be selectively permeable to all but any one gas in the feed gas.

Any number of membranes can be used to accomplish the separation. For example, one membrane can be used. The membranes can be manufactured as flat sheets or as fibers and can be packaged into any suitable variety of modules including hollow fibers, sheets or arrays of hollow fibers or sheets. Common module forms include hollow fiber modules, spiral wound modules, plate-and-frame modules, tubular modules and capillary fiber modules.

In embodiments, the membrane can be used to separate liquids. In some embodiments, the membrane can be used to separate a gas from a liquid. In another embodiment, the membrane can be used to separate a liquid from a gas. In another example, the membrane can be used to separate a gas from a gas that contains a suspended solid or liquid. In another example, the membrane can be used to separate a liquid from a liquid that contains a suspended or dissolved solid or gas.

### EXAMPLES

The present invention can be better understood by reference to the following examples which are offered by way of illustration. The present invention is not limited to the examples given herein.

### Reference Example 1: Membrane Preparation

Prior to preparing membranes, the compositions described in the Examples and Comparative Examples were placed in a vacuum chamber under a pressure of less than 50 mm Hg for 5 minutes at ambient laboratory temperature (21±about 2° C.) to remove any entrained air. Membranes were then prepared by drawing the composition described in the Examples into a uniform thin film with a doctor blade on a fluorosilicone-coated polyethylene terephthalate release film. The samples were then immediately placed into a forced air convection oven at a time and temperature sufficient to cure the films. For each composition, the curing schedule was determined by using differential scanning calorimetry to observe the temperatures at which the curing exotherms were observed. After curing, the membranes were then recovered by carefully peeling the cured compositions from the release film and transferred onto a fritted glass support for testing of permeation properties as described in Reference Example 2. The thickness of the samples was measured with a profilometer (Tencor P11 Surface Profiler).

### Reference Example 2

### Permeation Measurements

Gas permeability coefficients and ideal selectivities in a binary gas mixture were measured by a permeation cell including upstream (feed) and downstream (permeate) chambers that are separated by the membrane. Each chamber had one gas inlet and one gas outlet. The upstream chamber was maintained at 35 psi pressure and was constantly supplied with an equimolar mixture of CO₂ and N₂ at a flow rate of 200 standard cubic centimeters per minute (sccm). The membrane was supported on a glass fiber filter disk with a diameter of 83mm and a maximum pore diameter range of 10-20 μm (Ace Glass). The membrane area was defined by a placing a butyl rubber gasket with a diameter of 50 mm (Exotic Automatic & Supply) on top of the membrane. The downstream chamber was maintained at 5 psi pressure and was constantly supplied with a pure He stream at a flow rate of 20 sccm. To analyze the permeability and separation factor of the membrane, the outlet of the downstream chamber was connected to a 6-port injector equipped with a 1-mL injection loop. On command, the 6-port injector injected a 1-mL sample into a gas chromatograph (GC) equipped with a thermal conductivity detector (TCD). The amount of gas permeated through the membrane was calculated by calibrating the response of the TCD detector to the gases of interest. The reported values of gas permeability and selectivity were obtained from measurements taken after the system had reached a steady state in which the permeate side gas composition became invariant with time. All experiments were run at ambient laboratory temperature (21±about 2° C.).

### Example 1

Part A of a two part siloxane composition was prepared by combining a mixture including 99.6 parts of siloxane-silsesquioxane blend (Blend 1) including 73 parts of dimethylvinylsiloxy-terminated polydimethylsiloxane having a viscosity of about 55 Pa·s at 25° C. and 27 parts of organopolysiloxane resin including CH₂═CH(CH₃)₂SiO_{1/2} units, (CH₃)₃SiO_{1/2} units, and SiO_{4/2} units, wherein the mole ratio of CH₂═CH(CH₃)₂SiO_{1/2} units and (CH₃)₃SiO_{1/2} units combined to SiO_{4/2} units is about 0.7, and the resin has weight-average molecular weight of about 22,000, a polydispersity of about 5, and contains about 1.8% by weight (about 5.5 mole %) of vinyl groups, and 0.4 parts of a catalyst (catalyst 1) including a mixture of 1% of a platinum(IV) complex of 1,3-diethenyl-1,1,3,3-tetramethyldisiloxane, 92% of dimethylvinylsiloxy-terminated polydimethylsiloxane having a viscosity of about 0.45 Pa·s at 25° C., and 7% of tetramethyldivinyldisiloxane. Part A was mixed in a Hauschild rotary mixer for two 20 s mixing cycles followed by a 40 s mix, with a manual spatula mixing step between the first two cycles. Part B of the 2 part siloxane composition was prepared in a similar manner by combining 94.9 parts of Blend 1, and 4.7 parts of a polydimethylsiloxane-polyhydridomethylsiloxane copolymer having an average viscosity of 0.03 Pa·s at 25° C. and including 1 wt % H in the form of SiH (Crosslinker 1), and 0.4 parts of 2-methyl-3-butyn-2-ol.

### Comparative Example C1

Fifteen grams each of Part A and Part B described in Example 1 were combined in a polypropylene cup with 1.6 g of toluene and 0.01 g catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 30 min at 140 ° C. and tested as described in Reference Examples 1 and 2.

### Comparative Example C2

Ten grams each of Part A and Part B described in Example 1 were combined in a polypropylene cup with 9.2 g of ground quartz (Quartz) (MIN-U-SIL 5 by U.S. Silica (Berkeley Springs, W. Va.)), 1.5 g toluene and 0.04 g catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1 h at 160° C. and tested as described in Reference Examples 1 and 2.

### Comparative Example C3

Ten grams each of Part A and Part B described in Example 1 were combined in a polypropylene cup with 6.7 g of a mono-allyl, mono-acetate terminated polyethylene glycol having a number average molecular weight of about 600 g/mol (AAPEG), 6.7 g toluene, 1.9 g of a hydridosiloxy functional siloxane resin including (CH₃)₃SiO_{1/2} units, (CH₃)₂HSiO_{1/2} units and SiO_{4/2} units wherein the ratio of (CH₃)₂HSiO_{1/2} units to SiO₄₁₂ units is approximately 1.82, includes 1 wt % H in the form of SiH and has an average viscosity of 0.02 Pa·s at 25° C. (Crosslinker 2) and 0.05 g catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1 h at 160° C. and tested as described in Reference Examples 1 and 2.

### Comparative Example C4

Blend 1 (2.0 g) and 0.06 g of a polydimethylsiloxane-polyhydridomethylsiloxane copolymer having an average viscosity of 0.005 Pa·s at 25° C. and including 0.75 wt % H in the form of SiH (Crosslinker 2) were combined in a polypropylene cup with (in order) 0.01 g 1-ethynyl-1-cyclohexanol and 0.03 g catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1 h at 150° C. and tested as described in Reference Examples 1 and 2.

### Comparative Example C5

Blend 1 (2.0 g) and 0.06 g of Crosslinker 2 were combined in a polypropylene cup with 0.89 g Quartz and (in order) 0.01 g 1-ethynyl-1-cyclohexanol and 0.03 g catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1 h at 150° C. and tested as described in Reference Examples 1 and 2.

### Comparative Example C6

Blend 1 (2.0 g) and 0.45 g of Crosslinker 2 were combined in a polypropylene cup with 0.7 g of a diacrylate terminated polyethylene glycol having a number average molecular weight of about 700 g/mol (DACPEG) (Aldrich 455008) and (in order) 0.01 g 1-ethynyl-1-cyclohexanol and 0.03 g catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1 h at 150° C. and tested as described in Reference Examples 1 and 2.

### Comparative Example C7

A silicone composite was prepared by combining 2.915 g of dimethylvinylsiloxy-terminated poly(trifluoropropyl-methyl)siloxane having a viscosity of about 50 Pa·s at 25° C. (polymer F) and 0.070 g of trifluoropropyl-silsesquioxane having an average viscosity of 0.005 Pa·s at 25° C. and including 0.55 wt % H in the form of SiH (Crosslinker 3) in a 4-oz polypropylene cup. The components were mixed using a Hauschild rotary mixer for two 20 s cycles with a manual spatula mixing step in between cycles. Then, to the mixture was added 0.009 g of 2-methyl-3-butyn-2-ol and the components were again mixed using a Hauschild rotary mixer for two 20 s cycles with a manual spatula mixing step in between cycles. Then, to the mixture was added 1.284 g of Imerys C-4000 and the components were again mixed using a Hauschild rotary mixer for two 20 s cycles with a manual spatula mixing step in between cycles. Then, to the mixture was added 0.304 g of methylisobutylketone and the components were again mixed using a Hauschild rotary mixer for two 20 s cycles with a manual spatula-mixing step in-between cycles. Then, to the mixture was added 0.006 g of a catalyst containing a mixture of about 2% of a platinum(IV) complex of 1,3-diethenyl-1,1,3,3-tetramethyldisiloxane, 92% of dimethylvinylsiloxy-terminated poly(trifluoropropyl-methyl) siloxane, and 6% of tetramethyldivinyldisiloxane (catalyst 2) and the components were again mixed using a Hauschild rotary mixer for two 20 s cycles with a manual spatula mixing step in-between cycles. The composition was drawn into a membrane, cured for 2 h at 150° C. and tested as described in Reference Examples 1 and 2.

### Example 2

Ten grams each of Part A and Part B described in Example 1 were combined in a polypropylene cup with 4.8 g quartz, 3.2 g of a mono-allyl, mono-acetate terminated polyethylene glycol having a number average molecular weight of about 600 g/mol (AAPEG), 4.0 g toluene, 0.44 g Crosslinker 2, 0.97 g of a trimethylsiloxy-terminated poly(methylhydrogensiloxane/methyl-6,6,6,5,5,4,4,3,3-nonafluorohexylsiloxane) having an average of 28 methylhydrogensiloxane units and 12 methyl-6,6,6,5,5,4,4,3,3-nonafluorohexyl siloxane units per molecule (Crosslinker 3) and 0.05 g of catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1 h at 150° C. and tested as described in Reference Examples 1 and 2.

### Example 3

Ten grams each of Part A and Part B described in Example 1 were combined in a polypropylene cup with 13.4 g Quartz, 8.9 g of AAPEG, 2.3 g toluene, 2.5 g of Crosslinker 2 and 0.08 g of catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 30 min at 160 ° C. and tested as described in Reference Examples 1 and 2.

### Example 4

Five grams each of Part A and Part B described in Example 1 were combined in a polypropylene cup with 10.1 g Quartz, 6.7 g of AAPEG, 6.7 g toluene, 4.1 g of Crosslinker 3 and 0.08 g of catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1 h at 140° C. and tested as described in Reference Examples 1 and 2.

### Example 5

Five grams each of Part A and Part B described in Example 1 were combined in a polypropylene cup with 6.7 g Quartz, 4.5 g of a mono-allyl, mono-acetate terminated polyethylene glycol-polypropylene glycol copolymer having a number average molecular weight of about 1970 g/mol (AAPEGPPG) and a molar ratio of polyethylene glycol to polypropylene glycol units of about 1, 1.1 g toluene, 0.41 g Crosslinker 2, 0.04 g of catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1.5 h at 160° C. and tested as described in Reference Examples 1 and 2.

### Example 6

Five grams each of Part A and Part B described in Example 1 were combined in a polypropylene cup with 6.7 g Quartz, 4.5 g of a mono-allyl, mono-acetate terminated polyethylene glycol having a number average molecular weight of about 600 g/mol (AAPEG), 1.1 g toluene, 0.90 g Crosslinker 3, 0.05 g of catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 0.5 h at 160° C. and tested as described in Reference Examples 1 and 2.

### Example 7

One gram each of Part A and Part B described in Example 1 were combined in a polypropylene cup with 2.3 g Quartz, 1.2 AAPEGPPG, 0.3 g toluene, 0.10 g Crosslinker 3, 0.01 g of catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1.5 h at 155° C. and tested as described in Reference Examples 1 and 2.

### Example 8

One gram each of Part A and Part B described in Example 1 were combined in a polypropylene cup with 1.8 g Quartz, 1.0 AAPEGPPG, 0.3 g toluene, 0.30 g Crosslinker 3, 0.01 g of catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1.5 h at 155° C. and tested as described in Reference Examples 1 and 2.

### Example 9

Blend 1 (2.0 g) and 0.63 g of Crosslinker 2A were combined in a polypropylene cup with (in order) 1.36 g Quartz, 1 g of DACPEG (Aldrich 455008), 0.01 g 1-ethynyl-1-cyclohexanol, and 0.03 g catalyst 1 and mixed with a Hauschild rotary mixer for two 20 s cycles with a manual spatula mixing step in-between cycles. A 20 s mixing cycle was also used after the addition of each individual component. The composition was drawn into a membrane, cured for 1 h at 150° C. and tested as described in Reference Examples 1 and 2.

### Example 10

Blend 1 (2.0 g) and 0.46 g of Crosslinker 2A were combined in a polypropylene cup with (in order), 0.7 g of DACPEG (Aldrich 455008), 0.01 g 1-ethynyl-1-cyclohexanol, 0.17 g untreated fumed silica, and 0.03 g catalyst 1 and mixed with a Hauschild rotary mixer for two 20 s cycles with a manual spatula mixing step in between cycles. A 20 s mixing cycle was also used after the addition of each individual component. The composition was drawn into a membrane, cured for 1 h at 150° C. and tested as described in Reference Examples 1 and 2.

### Example 11

A silicone composite was prepared by combining 3.283 g of Polymer F and 0.194 g of Crosslinker 3 in a 4-oz polypropylene cup. The components were mixed using a Hauschild rotary mixer for two 20 s cycles with a manual spatula mixing step in between cycles. Then, to the mixture was added 0.304 g of methylisobutylketone and the components were again mixed using a Hauschild rotary mixer for two 20 s cycles with a manual spatula mixing step in between cycles. Then, to the mixture was added 0.641 g of AAPEG and the components were again mixed using a Hauschild rotary mixer for two 20 s cycles with a manual spatula mixing step in between cycles. Then, to the mixture was added 1.824 g of Imerys C-4000 and the components were again mixed using a Hauschild rotary mixer for two 20 s cycles with a manual spatula mixing step in between cycles. Then, to the mixture was added 0.091 g of Crosslinker 2 and the components were again mixed using a Hauschild rotary mixer for two 20 s cycles with a manual spatula mixing step in between cycles. Then, to the mixture was added 0.015 g of catalyst 2 and the components were again mixed using a Hauschild rotary mixer for two 20 s cycles with a manual spatula mixing step in between cycles. The composition was drawn into a membrane, cured for 14 h at 150° C. and tested as described in Reference Examples 1 and 2.

### Example 12

Five grams each of Part A and Part B described in Example 1 were combined in a polypropylene cup with 1.1 g toluene, 6.7 g Quartz, 4.5 g of AAPEG, 1.1 g toluene, 2.7 g of Crosslinker 3 and 0.08 g of catalyst 1 and mixed with a Hauschild rotary mixer for two 20 s cycles with a manual spatula mixing step in-between cycles. At least one 20 s mixing cycle was also used after the addition of each individual component to homogenize the mixture. The mixture was drawn down into a membrane according to the method of Reference Example 1, but just prior to placing the membrane into the curing oven, a 142 mm diameter Nylon support with a 0.22 micron pore size (Whatman) was gently placed into contact with the surface of the uncured film then transferred into a 140 degree C. oven for 1 hour to cure. The resulting membrane with porous support still attached was tested as described in Reference Example 2.

| | Cure | | CO₂ | N₂ | |
|---|---|---|---|---|---|
| | Temp. | Cure | Permeability | Permeability | CO₂/N₂ |
| Example | (° C.) | Time (h) | (Barrer) | (Barrer) | Selectivity |
| C1 | 140 | 0.5 | 3001 | 266 | 11.3 |
| C2 | 160 | 1 | 2847 | 266 | 10.7 |
| C3 | 160 | 2 | 2441 | 289 | 8.4 |
| C4 | 150 | 1 | 2182 | 209 | 10.4 |
| C5 | 150 | 1 | 1938 | 173 | 11.2 |
| C6 | 150 | 1 | 1440 | 113 | 12.7 |
| C7 | 150 | 2 | 268 | 19 | 13.9 |
| 2 | 150 | 1 | 4148 | 425 | 9.8 |
| 3 | 160 | 0.5 | 2442 | 107 | 22.8 |
| 4 | 140 | 1 | 2508 | 154 | 16.2 |
| 5 | 160 | 1.5 | 3282 | 256 | 12.8 |
| 6 | 160 | 0.5 | 2790 | 206 | 13.5 |
| 7 | 155 | 1.5 | 2497 | 153 | 16.3 |
| 8 | 155 | 1.5 | 2464 | 162 | 15.2 |
| 9 | 150 | 1 | 1343 | 100 | 13.4 |
| 10 | 150 | 1 | 1378 | 104 | 13.3 |
| 11 | 150 | 14 | 302 | 21 | 14.4 |
| 12 | 140 | 1 | 3603 | 252 | 14.3 |

| | Cure | Cure | CO₂ | CH₄ | |
|---|---|---|---|---|---|
| | Temp. | Time | Permeability | Permeability | CO₂/CH₄ |
| Example | (° C.) | (h) | (Barrer) | (Barrer) | Selectivity |
| C7 | 150 | 2 | 357 | 44 | 8.06 |
| 11 | 150 | 14 | 436 | 48 | 9.00 |

### Example 13

The procedure of Example 1 was followed with the amounts scaled to produce a batch having two times greater mass. Approximately 50 g of the mixed formulation was placed in a reservoir feeding into a die and concentrically coated over a polyvinylalcohol hollow fiber (MedArray, Inc) having an outer diameter of approximately 190 μm and a wall thickness of approximately 20 μm, using a drawing speed of approximately 6 m/min then immediately cured using an in-line tube furnace heated to approximately 130° C., following the process described in U.S. Pat. No. 6,797,212 B2. The continuous process was allowed to run for approximately 10 minutes, with the cured hollow fiber continuously collected onto a plastic spool. When examined by optical microscopy, the product was confirmed to be a cured silicone fiber coated on a hollow polyvinylalcohol support.

### Example 14

20 grams each of Part A and Part B described in Example 1 were combined in a polypropylene cup with 26.7 g quartz, 17.8 g of AAPEG, 4.5 g toluene, 3.3 g of Crosslinker 2, 10.1 g of a dimethylhydridosiloxy-terminated polydimethylsiloxane having a zero shear viscosity of approximately 10 cP and 0.21 g of catalyst 1 and mixed with a Hauschild rotary mixer for two 20 s cycles with a manual spatula mixing step in-between cycles. A 20 s mixing cycle was also used after the addition of each individual component. After further adding 4.0 g of toluene to the combined mixture and mixing to reduce the formulation viscosity, the composition was then concentrically die-coated over a hollow polyvinylalcohol fiber, cured and spooled as described in Example 13. The resulting fiber was examined by optical microscopy and confirmed to be a cured silicone fiber coated on a hollow polyvinylalcohol support. The inner diameter of each of the silicone fibers was approximately 190 μm, with a external wall thickness of approximately 55 μm.

### Example 15

Sections of the fiber produced in Example 14 were cut into 10 lengths of approximately 12 cm, and placed in a parallel gently twisted array in a polycarbonate tube. The tube and fibers were supported from the top in a vertical configuration, and the bottom end of the tube was filled with a few cm of polyurethane potting adhesive to seal one end of the module and allowed to cure. After curing, the tube was inverted such that the previously unsealed end was filled with polyurethane, and the curing process repeated. The potted fiber ends were then exposed by cleaving off a short segment of the potted section with a sharp guillotine-style cutter. Fittings were threaded into the polycarbonate tube to form a supported silicone hollow fiber module whose support could be removed by flowing deionized water through the bore of the fibers to yield a free standing silicone hollow fiber membrane module of the invention.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An unsupported membrane comprising:
a reaction product of a silicone composition, the silicone composition comprising
(A) an organopolysiloxane having an average of at least two silicon-bonded unsaturated aliphatic carbon-carbon bond-containing groups per molecule;
(B) an organo silicon compound having an average of at least two silicon-bonded hydrogen atoms per molecule;
(C) a polyether having at least one unsaturated aliphatic carbon-carbon bond-containing group per molecule;
(D) a siliceous filler; and
(E) a hydrosilylation catalyst;
wherein the membrane is unsupported.

2. The unsupported membrane of claim 1, wherein the organopolysiloxane having an average of at least two silicon-bonded unsaturated aliphatic carbon-carbon bond-containing groups per molecule comprises a silicone resin.

3. The unsupported membrane of claim 1, wherein the silicone resin comprises R¹₂R²SiO_{1/2} siloxane units and SiO_{4/2} siloxane units wherein each R¹ is independently selected from monovalent hydrocarbon and monovalent halogenated hydrocarbon groups, both free of aliphatic unsaturation, R² is R¹ or alkenyl, the mass ratio of R¹₂R²SiO_{1/2} units to SiO_{4/2} units is from about 4:1 to about 2.3:1, and the resin contains an average of from about 0.33 to about 0.45 mass percent of alkenyl groups.

4. The unsupported membrane of claim 1, wherein the siliceous filler is selected from mica, crystalline quartz, ground quartz, diatomaceous silica, fumed silica, fused quartz, silica gel, and precipitated silica.

5. The unsupported membrane of claim 1, wherein the siliceous filler is ground quartz.

6. The unsupported membrane of claim 1, wherein the membrane has a thickness of from 0.1 to 200 μm.

7. A supported membrane, comprising:
a substrate, comprising a porous substrate or a highly-permeable nonporous substrate; and
a membrane comprising a reaction product of the silicone composition on the porous substrate;
the silicone composition comprising
(A) an organopolysiloxane having an average of at least two silicon-bonded unsaturated aliphatic carbon-carbon bond-containing groups per molecule;
(B) an organo silicon compound having an average of at least two silicon-bonded hydrogen atoms per molecule;
(C) a polyether having at least one unsaturated aliphatic carbon-carbon bond-containing group per molecule;
(D) a siliceous filler; and
(E) a hydrosilylation catalyst;
wherein the membrane is a supported membrane.

8. The supported membrane of claim 7, wherein the substrate is a frit comprising a material selected from glass, ceramic, alumina, and a porous polymer.

9. A method of separating gas components in a feed gas mixture, the method comprising:
contacting a first side of a membrane comprising a reaction product of a silicone composition with a feed gas mixture comprising at least a first gas component and a second gas component to produce a permeate gas mixture on a second side of the membrane and a retentate gas mixture on the first side of the membrane,
wherein the permeate gas mixture is enriched in the first gas component, the retentate gas mixture is depleted in the first gas component, and the silicone composition comprises
(A) an organopolysiloxane having an average of at least two silicon-bonded unsaturated aliphatic carbon-carbon bond-containing groups per molecule;
(B) an organo silicon compound having an average of at least two silicon-bonded hydrogen atoms per molecule;
(C) a polyether having at least one unsaturated aliphatic carbon-carbon bond-containing group per molecule;
(D) a siliceous filler; and
(E) a hydrosilylation catalyst.

10. The membrane of claim 1, wherein the membrane has a CO₂/N₂ selectivity of at least about 10.

11. The membrane of claim 1, wherein the membrane has a CO₂ permeability coefficient of at least about 300 Barrers.

12. The membrane of claim 1, wherein the membrane has a CO₂/CH₄ selectivity of at least about 3.

13. The membrane of claim 1, wherein the membrane is selected from a plate membrane, a spiral membrane, tubular membrane, and hollow fiber membrane.

14. The method of claim 9, wherein the feed gas mixture comprises carbon dioxide and nitrogen.

15. The method of claim 9, wherein the feed gas mixture comprises carbon dioxide and methane.

16. The method of claim 9, wherein the feed gas mixture comprises water vapor.

17. The membrane of claim 7, wherein the membrane is selected from a plate membrane, a spiral membrane, tubular membrane, and hollow fiber membrane.

18. The membrane of claim 7, wherein the membrane has a CO₂/N₂ selectivity of at least about 10.

19. The membrane of claim 7, wherein the membrane has a CO₂ permeability coefficient of at least about 300 Barrers.

20. The membrane of claim 7, wherein the membrane has a CO₂/CH₄ selectivity of at least about 3.
